(19) United States
(12) Patent Application Publication
(10) Pub. No.: US 2008/0195597 A1
(43) Pub. Date: Aug. 14, 2008

(54) Searching in peer-to-peer networks

(75) Inventors: Avi Rosenfeld, Modiln (IL); Gal A. Kaminka, Kfar-Saba (IL); Sarit Kraus, Givat Shmuel (IL)

Correspondence Address: Martin D. Moynihan;PRTSI, Inc., P.O. Box 16446, Arlington, VA, 22215, US

(73) Assignee: Samsung Electronics Co., Ltd., Suwon-si (KR)

(21) Appl. No.: 11/703,758

(22) Filed: Feb. 8, 2007

(51) Int. Cl. G06F 17/30

(52) U.S. Cl. 707/5

(57) ABSTRACT

A searching system for a peer-to-peer network, for example, a cellular telephone network, where loads on each peer is limited, for example, by providing only a limited index on each peer.

### FIELD OF THE INVENTION

The present invention relates to searches within peer-to-peer (P2P) networks. Some embodiments relate to peers with limited resources such as cellular devices.

### BACKGROUND

Text searching, or the ability to locate documents based on terms from within a document, is indispensable for locating information in distributed networks such as peer-to-peer (P2P) networks

Two basic approaches have been proposed for text searches within P2P networks.

One approach is a structured search where a peer uses information about the system or data organization to find a data item. The data organization may comprise an index that provides information where a item is located. The index may be centralized such as on a server, divided among dedicated units (‘super-nodes’), or distributed between peers connected to the network. See, for example, Luis Gravano, H'ector Garc'a-Molina, and Anthony Tomasic. Gloss: text source discovery over the internet. ACM Trans. Database Syst., 24(2):229.264, 1999, or Qin Lv, Pei Cao, Edith Cohen, Kai Li, and Scott Shenker. Search and replication in unstructured peer-to-peer networks. In ICS '02: Proceedings of the 16th international conference on Supercomputing, pages 84.95, New York, N.Y., USA, 2002, ACM Press, the disclosure of which is incorporate herewith by reference. An index may be constructed, for example, as peers publish terms within their documents in an index upon joining the network.

Another approach is an unstructured search where the search is based on visiting peers in the system without relying on prior information about the system or data organization, but, rather, following an arbitrary sequence, such as random walk between the peers See, for example, Yong Yang, Rocky Dunlap, Michael Rexroad, and Brian F. Cooper. Performance of full text search in structured and unstructured peer-to-peer systems. In IEEE INFOCOM, 2006, the disclosure of which is incorporate herewith by reference.

### SUMMARY OF THE INVENTION

An aspect of some embodiments of the invention relates to a system for searching in a peer-to-peer (P2P) network using indexes distributed among peers in the network while limiting the demand on the resources of the peers.

Of particular, not necessarily limiting, interest are portable devices in a wireless communications system, such as cellular phones or devices over a cellular network. Cellular phones are frequently characterized by limited resources of the devices (e.g. memory, energy and computing power) and communications cost, for either or both of the sending and receiving ends, as well as limited communications bandwidth. Another characteristic is the dynamics of the system as units may randomly connect or disconnect, thus changing the system and possibly disturbing its consistency and reducing the available space for the distributed indexes and data.

In exemplary embodiments of the invention, a limit is imposed on a size parameter of the index. In an exemplary embodiment of the invention, the limit is a total size of n of the index. Alternatively or additionally, a peer has a limit for the number of entries it stores in its index. Alternatively or additionally, a peer has a limit for the number of entries for each term it stores in its index. In an exemplary embodiment of the invention, for a given term that is indexed, the percentage of entries is less than 50%, less than 30%, less than 10%, less than 1% or intermediate percentages of entries that could be provided for that term. Optionally, these percentages are correct on the average for all or at least 90% of the terms indexed in a peer.

Optionally, the limit is applied and/or maintained for the peer as a whole. Alternatively or additionally, a sub-limit is applied to a part of the index.

In exemplary embodiments of the invention, the limited index size causes dividing an index between a plurality of peers, possibly independent of redundancy considerations. In an exemplary embodiment of the invention, each peer has stored thereon less than 30%, less than 15%, less than 5%, less than 1%, less than 0.5% or intermediate percentages of an index maintained in the peer-to-peer network for documents searchable by the peers using terms. Optionally, these percentages are percentages of terms covered. Alternatively or additionally, the percentages are percentages of documents covered. Alternatively or additionally, the percentages are percentages of term locations covered.

In exemplary embodiments of the invention, the limited index size is on the expense of non-indexed terms instances, which are discarded. Alternatively or additionally, terms that appear in, or associated with, the source document more than once may be discarded in favor of indexing of terms that appear only once. Alternatively or additionally, frequent terms may be discarded in favor of infrequent ones. Optionally, the terms instances are indexed responsive to a priority, for example the popularity of terms or importance. In some embodiments, when a term is discarded, a count is maintained of the discarded term or other entry type.

It should be noted that discarded terms may still be found by an unstructured search, and if they are frequent, optionally without incurring undue cost. It is a particular feature of some embodiments of the invention that the size of index and/or memory or other load caused by the index can be traded-off with the cost of performing an unstructured search.

In exemplary embodiments of the invention, the limited index size facilitates indexing and searching of full-text documents, which, otherwise, might require impractical or prohibitive index sizes.

In an exemplary embodiment of the invention, when searching for a term or a combination of terms (‘query’), the distributed indexes for the term or terms are consulted to find documents that comprise, or associated with, the terms.

Optionally, the search comprises a peer contacting other peers and querying their respective index to locate an index for a document or the document itself. Optionally, a peer sends at least a part of an index to a requesting peer. Optionally, a peer forwards at least part of its index to other peers to assist in converging on documents comprising all terms of the query and/or otherwise matching the query.

Limiting the size of the index in a peer optionally contributes at least one of four related benefits: (a) the memory capacity of the device is not substantially consumed or exhausted, (b) the traffic volume in searches and, optionally, other processes is limited and so is the cost which may be responsive to time and/or volume of data, (c) the bandwidth is conserved, and (d) energy (e.g., battery life) is conserved.

In exemplary embodiments of the invention, limiting the size of an index stored on a peer reduces the effect due to a missing peer, since the amount of missing data is limited. The limited missing data optionally allows lowering the obligation to remedy the system, which may reduce the remedy traffic and cost and/or bandwidth utilization.

In exemplary embodiments of the invention, limiting the size of an index stored on a peer allows to replicate an index from one peer into another in addition to an existing index for a term. The replication enables one peer to store an index for a term that is stored also on another peer, enlarging the redundancy and/or durability of the system. Optionally, only part of an index is replicated. Optionally, only the term is replicated and different entries are provided.

In exemplary embodiments of the invention, the number of search results is limited so that beyond a certain threshold number, the system considers the search as complete.

This limitation may limit the traffic used in a search and reduce the cost and bandwidth unitization for too exhaustive a search that may not be necessary or essential (since a substantially number of documents was already obtained). Optionally or additionally, the searched peers may record what documents were found for the query. Optionally, if deemed necessary and/or requested, the search may be resumed and only documents that were not found in a preceding search will be searched and reported, increasing the extent of the search while avoiding redundant search operations, and, optionally reducing the traffic volume and costs.

It should be noted that a user may tradeoff quality of search with other parameters, such as immediacy of result (e.g., limit the search to whatever can be found in a limited time period) and/or a user may trade-off cost with quality, for example, agreeing to have a search “fail” even if better results were available, but at a cost.

In exemplary embodiments of the invention, a search may comprise of physical and/or operational criterions. For example, searching for peers (which store documents) that are in a certain location boundaries, that are within certain distance, or that are active for a certain time.

Optionally, such physical and/or operational criterions may be combined in terms search so that less costly peers will be contacted when possible. For example, a closer peer may be the less expensive to contact (or be available for direct exchange of information, such as using Bluetooth technology), or calling a peer at night may be cheaper due to special rates.

In exemplary embodiments of the invention, the search may comprise of at least one of a structured or unstructured search, or a combination thereof.

In exemplary embodiments of the invention, a plurality of search sessions may be active in parallel. Optionally or additionally, a peer may be involved in a session as a querying pear and in a parallel session as a responding peer.

An aspect of some embodiments of the invention relate to a search among peers in a P2P network where the search combines a structured and unstructured search responsive to cost of the search and/or other considerations, such as availability and time to respond. For example, if cost for transmission is low (e.g., at weekends) and time is not an issue, an unstructured search may be used, even for infrequent terms. If time and cost are an issue a structured search or a combined structured and unstructured search may be preferred.

In exemplary embodiments of the invention, a tradeoff of costs of the combination of structured and unstructured search is calculated or estimated, aiming to reduce the cost of the search.

In exemplary embodiments of the invention, the cost is related to the frequency of a term in a search query. Alternatively or additionally, the cost is related to the size of index for a term in the query so that tuning the size of the index would result in a tradeoff between low volume traffic of low cost with low demand on the peers and adequate index size for substantially sufficient results.

In exemplary embodiments of the invention, the frequency of terms in the system may be found substantially accurately. Optionally, the system maintains a common counter of the number of documents in the system for substantially reliable terms frequency calculation. It should be noted that the counter may be provided at multiple location and not be the same at all locations.

In exemplary embodiments of the invention, the combination of searches is responsive to partial results from a previous search.

In exemplary embodiments of the invention, responsive to cost estimation, an unstructured search is conducted first, optionally for frequent terms, followed by structured search for less frequent terms. Alternatively or additionally, the opposite order is conducted. Optionally, the sequence may be repeated.

An aspect of some embodiments of the present invention relates to a method for a remedy of churning (random disconnection of peers) so that the data consistency is substantially maintained. In an exemplary embodiment of the invention, the churn is over 40% or over 60%. This churn may be measured, for example, on all peers or only on peers that are relatively available.

In exemplary embodiments of the invention, a disconnection is detected or assumed, and the disconnected peer is waited to check if it returns within a time estimated sufficient for a momentary disconnection (e.g. due to being busy or low signal) or it is estimated that it is a long term disconnection. In the first case, the returning peer is optionally updated for possible missed data, and in the latter case, optionally, a supplementary peer is given the role of the missing peer. In an exemplary embodiment of the invention, momentary disconnection is assumed to be less than 1 hour, less than 5 minutes, less than 1 minute, less than 20 seconds or intermediate values. The times may be selected to reflect typical cellular telephone usage, for example, meetings, temporary bad signal locations, short telephone conversations that force unavailability, tunnels, blind spots caused by buildings and/or topography and/or random interference.

In an exemplary embodiment of the invention, redundancy is provided to assist with overcoming chum adverse effects.

An aspect of some embodiments of the invention relates to a method of estimating the frequency of search terms in a peer-to-peer system, in which a peer first obtains an estimate of the relative count of terms and uses that count to estimate the frequency of search terms.

In an exemplary embodiment of the invention, the peer obtains the relative count as a document count.

In an exemplary embodiment of the invention, the peer estimates the frequency of search terms based on an analysis of locally stored documents and/or a locally stored index of terms.

Aspect of some embodiments of the invention relates to a search method in a peer-to-peer network in which a search includes two stages, a first stage of obtaining information about the search request by contacting one or more peers or other stations and a second stage of performing a search. Additional stages may be provided as well, for example, a follow-up search after results are in and/or based on user feedback.

In an exemplary embodiment of the invention, the obtained information comprises obtaining an estimation of search term frequency. Alternatively or additionally, the obtained information comprises indicates an expected cost of searching, for example, an estimated size of indexes to be transferred.

There is therefore provided in accordance with an exemplary embodiment of the invention, a peer adapted for use in a peer-to-peer network, comprising:

(a) a memory storing therein only a part of an index of items available for search by said peer;

(b) a search module configured to search using the part of the index and corresponding parts stored on other peers; and

(c) a limiting module configured to maintain a load on said peer below a threshold.

In an exemplary embodiment of the invention, said load comprises a processing load of said peer. Alternatively or additionally, said load comprises an energy load of said peer. Alternatively or additionally, said load comprises a communication load of said peer.

In an exemplary embodiment of the invention, said load comprises a memory load of said peer. Optionally, said memory load is limited as an absolute amount of memory. Alternatively or additionally, said memory load is limited as a percentage of a peer resource. Alternatively or additionally, said memory load limit is an absolute limit. Alternatively or additionally, said memory load limit is an average limit. Alternatively or additionally, said memory load limit comprises a limit on number of terms indexed for said items. Alternatively or additionally, said memory load limit comprises a limit on an amount of information stored per term. Alternatively or additionally, said part of an index includes a count of said available items. Alternatively or additionally, said part of an index includes an indication of a count of said terms whose indexing is incomplete.

In an exemplary embodiment of the invention, said limit includes at least one static component.

In an exemplary embodiment of the invention, said limit includes at least one dynamic component that changes at least once a day. Optionally, said dynamic component depends on at least one of peer available resources and a costing scheme used by the peer.

In an exemplary embodiment of the invention, the peer comprises a memory storing therein at least ten documents available for said searching.

In an exemplary embodiment of the invention, the peer comprises a publishing module configured to publish to other peers terms indexible for an item.

In an exemplary embodiment of the invention, the peer comprises an un-publishing module configured to un-publish a previously published item.

In an exemplary embodiment of the invention, the peer comprises a term matching module configured to match a term to said part of an index.

In an exemplary embodiment of the invention, the peer comprises an output module configured to output at least one of:

(a) a part of said part of an index;

(b) a link to an item; and

(c) a document or document portion.

In an exemplary embodiment of the invention, the peer comprises a frequency estimation module configured to estimate a frequency of a term.

In an exemplary embodiment of the invention, the peer comprises a tradeoff estimation module configured to estimate a tradeoff between two or more search parameters. Optionally, said tradeoff estimation module is configured to select a search type based on said estimation.

In an exemplary embodiment of the invention, said search module is adapted to execute an unstructured search.

In an exemplary embodiment of the invention, said search module is adapted to execute a structured search.

In an exemplary embodiment of the invention, said search module is adapted to execute a combined structured and unstructured search.

In an exemplary embodiment of the invention, said part of an index comprises an index for a full-text search.

In an exemplary embodiment of the invention, said peer is a battery limited mobile device. Optionally, said peer is a cellular telephone.

There is also provided in accordance with an exemplary embodiment of the invention a network comprising a plurality of peers as described above.

In an exemplary embodiment of the invention, not all of said peers have the same limits.

In an exemplary embodiment of the invention, the network comprises at least one non-peer member, which participates in at least one of searching and storage of documents.

In an exemplary embodiment of the invention, no peer has stored thereon more than 5% of a combined index available for said items.

In an exemplary embodiment of the invention, the network comprises a redundancy of storage of indexes of at least a factor of 2. Optionally, redundant peers do not exactly duplicate each other.

There is also provided in accordance with an exemplary embodiment of the invention, a method of index management in a peer-to-peer network, comprising:

(a) distributing an index between a plurality of peers; and

(b) enforcing a size limit on the index at each peer. Optionally, enforcing comprises replacing index entries. Alternatively or additionally, enforcing comprises dropping index entries.

In an exemplary embodiment of the invention, the method comprises performing a structured search using said limited indexes. Optionally, said search includes an unstructured component.

There is also provided in accordance with an exemplary embodiment of the invention, a method of searching in a peer-to-peer network, comprising:

(a) evaluating at least one consideration regarding the search; and

(b) based on said, evaluation performing at least one of a structured search, and unstructured search or a combined structured and unstructured search. Optionally, said search comprises a full-text search. Alternatively or additionally, said consideration comprises cost. Optionally, said cost comprises a cost to a peer requesting the search. Alternatively or additionally, said cost comprises a cost to the network.

In an exemplary embodiment of the invention, said consideration comprises time.

In an exemplary embodiment of the invention, said consideration comprises a frequency of one or more terms used in the search. Optionally, said frequency is based on a count of searchable items in said network. Alternatively or additionally, said frequency is based on a count of terms in said network.

In an exemplary embodiment of the invention, said combined search comprises search structured and unstructured at a same time. Alternatively or additionally, said combined search comprises search structured and unstructured in series. Alternatively or additionally, said combined search is based on results received during said search. Alternatively or additionally, said combined search is based on prior provided information.

There is also provided in accordance with an exemplary embodiment of the invention a method of combating adverse chum effects in a peer-to-peer network, comprising:

(a) providing a peer-to-peer system with required data distributed among the peers;

(b) monitoring availability of peers;

(c) identifying that a peer is unavailable;

(d) distinguishing if the unavailability is momentary; and

(e) applying a back-up procedure if it is determined that said unavailability is not momentary. Optionally, said back-up procedure comprises activating a redundant peer. Alternatively or additionally, said back-up procedure comprises publishing information previously stored on said peer to one or more other peers. Alternatively or additionally, said peer-to-peer network stores the data in a redundant form.

There is also provided in accordance with an exemplary embodiment of the invention a method of estimating the frequency of a term use in a peer-to-peer system, comprising:

(a) requesting form at least one peer, one or both of a count of term use and a document count; and

(b) analyzing information received in response to said request, to generate a frequency estimation. Optionally, said request comprise a request for a document count. Alternatively or additionally, said request comprise a request for a term count. Alternatively or additionally, said request is made to a plurality of at least 10 peers. Alternatively or additionally, analyzing comprises analyzing based on one or both of local term usage.

There is also provided in accordance with an exemplary embodiment of the invention a method of searching in a peer-to-peer network, comprising:

(a) contact a plurality of peers to receive preliminary information regarding the search; and

(b) based on said preliminary information sending a search request to a plurality of peers. Optionally, said contacting comprises receiving information suitable to estimate a cost of a search.

### BRIEF DESCRIPTION OF DRAWINGS

In the drawings which follow, identical structures, elements or parts that appear in more than one drawing are generally labeled with the same numeral in all the drawings in which they appear. Dimensions of components and features shown in the drawings are chosen for convenience and clarity of presentation and are not necessarily shown to scale.

FIG. 1 is a schematic illustration of a peer-to-peer network comprising peers represented by a plurality of cellular phones in a cellular network, in accordance with an exemplary embodiment of the invention;

FIG. 2 is a schematic illustration of documents stored in peers and their distributed indexes for terms of the documents, in accordance with an exemplary embodiment of the invention;

FIG. 2A is a schematic illustration a structure and contents of an index of FIG. 2, in accordance with exemplary embodiments of the invention;

FIG. 3A is a flowchart of publishing terms in a document from a source peer to a destination peer, in accordance with an exemplary embodiment of the invention;

FIG. 3B is a flowchart of publishing terms in a document at a receiving peer, in accordance with an exemplary embodiment of the invention;

FIG. 4A is a flowchart of un-publishing terms in a document from a source peer to a destination peer, in accordance with an exemplary embodiment of the invention;

FIG. 4B is a flowchart of un-publishing terms in a document at a receiving peer, in accordance with an exemplary embodiment of the invention;

FIG. 5 is a flowchart of a remedy for a missing peer, in accordance with an exemplary embodiment of the invention;

FIG. 6 is a flowchart of a search combining structured and unstructured search, in accordance with an exemplary embodiment of the invention;

FIG. 7 is a flowchart of a method determining a cost tradeoff between structured and unstructured searches, in accordance with an exemplary embodiment of the invention; and

FIG. 8 schematically illustrates how the number of index entries per peer (load) is effected by the size of a term-index and the available number of peers, in accordance with an exemplary embodiment of the invention.

### DETAILED DESCRIPTION OF EMBODIMENTS

The following description is arranged according to topics, starting with general subjects and basics procedures for preparing and maintaining the peers system, on to searching and cost evaluations.

### The Network

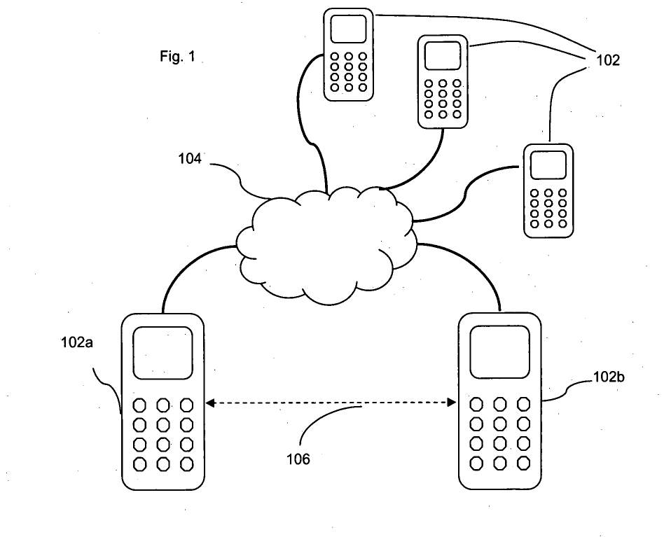

FIG. 1 is a schematic illustration of a peer-to-peer network comprising peers represented by a plurality of cellular phones 102 in a cellular network 104. A connection between peers is illustrated by a connection line 106 between peers 102a and 102b. The connection may be a direct one such as in a Bluetooth network or an infrared link, or a virtual (indirect) connection such as in a cellular network, for example, by dialing one another via the cellular network facilities, or using an IP connection method supported by the network.

In exemplary embodiments of the invention, the network may comprise other cellular devices or non-cellular devices as peers, such as portable music or video players, PDAs (personal data assistant) and personal or portable computers. Optionally, a mixture of device types may be used as peers.

In exemplary embodiments of the invention, the network may comprise of non-cellular and/or non-peer devices such as IP stations, servers and proxies, base stations, relay units and routers.

In exemplary embodiments of the invention, cellular devices such as cellular phones are used to illustrate how indexes may be distributed between peers with limited resources regarding memory capacity (e.g., RAM, EEPROM), energy reserves (e.g., battery), and computing power (e.g., CPU) that communicate, for possibly considerable costs, over a limited bandwidth infrastructure.

### Network Connections

In exemplary embodiments of the invention, an algorithm of ring organization, or connection topology, such as Chord is used to find a peer or peers 102 by their identification information, e.g. a unique key such as a phone number. See, for example, Robert Morris, David Karger, Frans Kaashoek, and Hari Balakrishnan, Chord: A Scalable Peer-to-Peer Lookup Service for Internet Application, In ACM/SIGCOMM2001, San Diego, Calif., September 2001, the disclosure of which is incorporated herewith by reference. Optionally or alternatively, other techniques of the art may be used to locate peers 102. For example, algorithms that provide the basic capability of mapping a key onto a node (peer) and comprise the capability of locating data by associating a key with a data and storing the key/data item pair at the node to which the key maps.

Typically, algorithms such as Chord can locate a data item on a peer through hops, or steps, proportional to, or in the same order of, log₂N, where N is the number of peers in the system.

Optionally or alternatively, the peers are registered on a server in some structure or database and peers are picked up and/or traversed based on interrogation of the list or database. Optionally, the database is stored on the peers, or on some of the peers.

Optionally or alternatively, other methods for picking and locating peers may be used, for example, accessing the cellular provider services.

In exemplary embodiments of the invention, the data exchange uses intermediates, or proxies, between peers. Optionally, a proxy may cache messages to enhance the system efficiency. Optionally, the proxy is part of the peers' organization. Optionally or alternatively, the proxy may be part of the underlying network.

### Peers and Indexing

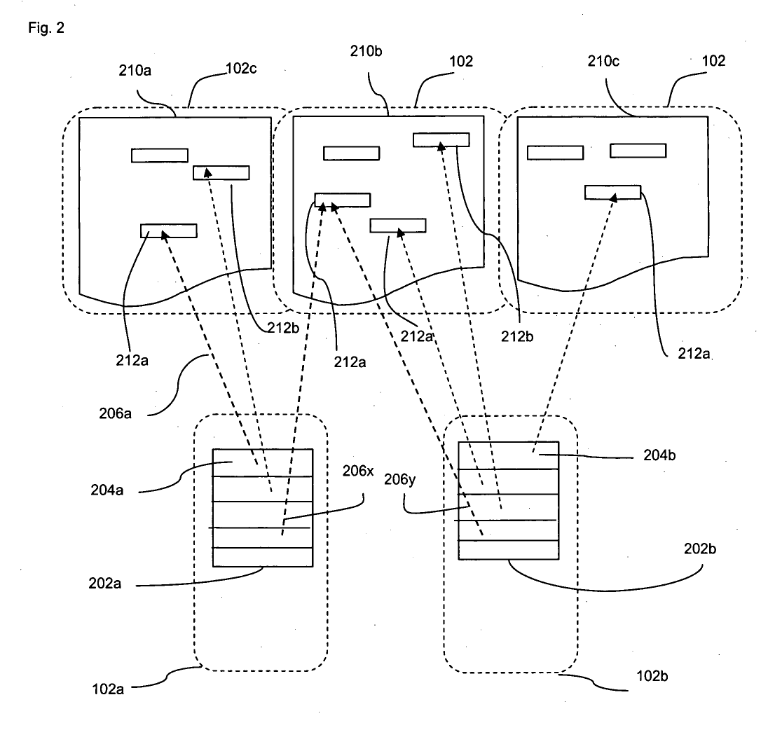

FIG. 2 is a schematic illustration of documents 210 stored in peers 102 and their distributed indexes 202 for terms 212 of the documents.

Documents 210 may optionally be any object comprising or associated with textual data such as text files, text messages, music tagged with data such as album, vocalist, or type of music, or images tagged with keywords (e.g. EXIF) such as date and location, or movies with a review or tagged data such as name, actors, director and such. In some embodiments of the invention physical items (e.g., including services) which cannot be stored on the cellular telephones are indexed for finding using the methods as described herein.

In exemplary embodiments of the invention, term 212 is a word or word sequence in a document. Optionally, a term is a stemmed word, or a root of a word, ignoring inflections and other variations of the word. For example, ‘connect’, ‘connecting’, and ‘connected’ are considered as one term ‘connect’. Furthermore, depending on the design guidelines, words like ‘connector’ and ‘connectedness’ may be considered as the same term ‘connect’. In some embodiments, a term is stored as a stem but an index entry is optionally used to identify the non-stem components of the term.

In some embodiments of the invention, stemming reduces the number of terms 212 for publishing and storing in index 204. Optionally or additionally, stemming improves the accuracy of searches.

In exemplary embodiments of the invention, the data may comprise non-textual attributes such as date (e.g., of creation) or non-document information, such as proximity or geographical region of a peer or data storage, or cost program of a peer, or operational attributes such as response time.

Peers 102 may obtain documents 210 by various manners. For example, downloading from the internet (e.g. by protocols such as GPRS), receiving from other peer such as by SMS, or connecting to other sources by LAN or Bluetooth or via USB or other connections. A peer may acquire the data directly such as by taking pictures or recording sound or video. Optionally, peers 102 do not store some documents 210 but, rather, have direct access to them on another device, for example, documents 210 are stored in a computer and a cellular phone (peer 102) access them via connections such as Bluetooth, USB or Internet.

In exemplary embodiments of the invention, documents, and terms associated with documents may be acquired from other phones or devices via cellular communications or wireless network by entering a certain geographical location such as proximity to a document provider or by transmitting certain information. For example, walking in a street a cellular phone may transmit images it took on the street to close by phone, or a wireless network may transmit some recent news.

In exemplary embodiments of the invention, the indexes are of an ‘inverted file’ type, where the term “inverted” is in contrast to the documents themselves. An inverted file stores for a document a list of the terms it contains or is associated with (such as tagging). Optionally, the terms are hashed for economical storage (such as by Bloom filter). Optionally or additionally, other techniques of indexing as known in the art may be used, including, for example, not indexing very common words such as (for English) “the”, “a” and “and”.

In exemplary embodiments of the invention, an index such as 202a comprises one or more entries such as 204a that indicates one or more document 210a (or portion thereof) on peer 102c, as illustrated by a link arrow 106a.

Optionally, index 202 comprises additional information such as the number of occurrences of a term in a document. For example, index 202b can hold for term 212a a count 2 representing the number of times term 212a appears in document 210a.

FIG. 2A is a schematic illustration a structure and contents of an index of FIG. 2, in accordance to exemplary embodiments of the invention.

A section 240 of index 204 is dedicated to a particular term (e.g. ‘Jerusalem’), wherein that term is stored as part of the index such as in a header, or in a directory of a peer (index to indexes, or pointers to indexes). In the example of FIG. 2A, the terms ‘Jerusalem’ and ‘London’ are stored at a dedicated location (232) as headers.

For clarity, index 204 stored on peers 102 will be denoted, unless otherwise specified, as ‘peer index’, and section 240 of a particular term 212 will be denoted, unless otherwise specified, as ‘term-index’. In case peer 102 stores an index only for one particular term then ‘index’ and ‘term-index’ substantially denote the same entity.

A basic component 236 of entry 204 of term-index 240 comprises an indication of document 210, such as a file name (e.g. ‘news 1-jan.txt’, ‘concert no 3-7.mp3′’), and where the document is stored, such as the source peer id (e.g. phone number, 972-3-8680320).

Additional, optional information beyond the basic component, is shown as the number of occurrences of the term (e.g. ‘Jerusalem’) in, or associated with, document. For example, in FIG. 2A the term-‘Jerusalem’appear 5 times in ‘news 1-jan.txt’ and 2 times in a tag of ‘concert no 3-7.mp3’ (e.g. a concert in Jerusalem by the Jerusalem philharmonic orchestra).

Optionally, term-index 240 comprises the location of term 212 in document 210. Optionally it is the location of first appearance of term 212 in or with document 210. Optionally or additionally, the locations of more terms, or all the terms in a document are stored in entry 204 of term-index entry 240.

Optionally, other information may be indexed in entry 204 of term-index 240, such as the size and type of the document, and non-textual information such as response time of a source peer.

In exemplary embodiments of the invention, a peer stores an index of at least one term. Optionally, a peer is dedicated to a particular term, for example, peer 102a stores index 202 only for term ‘Jerusalem’. Optionally, the contents of index 202 of a term 212 are replicated, at least partially on more than one peer 102, as illustrated for item 212a in document 210b by linkage lines 206x and 206y. Optionally, each (or most) peer includes an index for a plurality of terms, such as 10, 100, 1000 or more or intermediate numbers.

Redundancy of term-indexes 240 among peers 103 (or at least part of their contents so the redundancy may be partial between two or more peers) can enhance the system durability.

For example, if peer 102 holding term-index 240 for term or terms 212 fails or disconnects from network 104, there may still be other peers 102 with term-index 240, or at least part of it, for those terms 212.

Another example is that, communication and operation of peers is typically not infallible, so that data may be missing or inconsistent. In such a case, redundancy may complement and/or fix missing or corrupted data.

Optionally, the redundancy may increase the speed, or reduce the cost, of finding a required term-index 240 for term 212.

In an exemplary embodiment of the invention, peer-indexes 202 or term-indexes 240 are distributed substantially equally among peers 102 in network 104, for example, by giving no preference for index size to any peer. Optionally or alternatively, for one or more terms 212, some peers may store a larger term-index 240 than other peers do.

In exemplary embodiments of the invention, redundant indexes are stored in peers that form a group in terms of the organization of the system, for example, a predecessor/successor peer in a Chord ring. Optionally, a group may be constructed, or implied, from other organization such as registered peers in a server.

In exemplary embodiments of the invention, indexes 202 are not necessarily distributed substantially equally among peers 102, so that at least one peer 102, or device, stores a substantial share of the peer-indexes and/or store an index of which terms are covered by which peer (e.g., it can act ‘super-nodes’). Optionally, one or more super-nodes store the indexes of the system, with or without redundancy. It should be noted that super-nodes may be faster to reach and find term-indexes, but they may impose and/or necessitate dedicated units and special organization. Moreover, the data integrity and coverage may then be dependent on the super-nodes. Optionally, the super nodes are available for use at a cost.

### Global Document Count

In exemplary embodiments of the invention, at least one peer is dedicated to store the number of documents in the system. Optionally, a plurality of peers store the number of documents, the redundancy enhancing the integrity of the data. Optionally or additionally, a peer for storing the number of documents is a regular peer 102. Optionally and additionally, peer 102 stores peer-index 202 and the number of documents in the system. The number of documents may be useful in search tactics as described later on. It should be appreciated that the different peers storing document count may be out of synch with each other, for example, there may be a difference in count, of, for example, 10% or more between peers.

### Index Limit

In exemplary embodiments of the invention, peer 102 has a limit for the number of entries 204 it stores in its peer-index 202.

Optionally, peer 102 has a limit for the number of entries for each term 212 it stores in its term-index 240.

In exemplary embodiments of the invention, the limited index size can cause the dividing of an index over more than one peer.

In exemplary embodiments of the invention, the limited index size facilitates indexing and searching of full-text documents, which, otherwise, would require impractical or prohibitive index sizes.

In exemplary embodiments of the invention, a full-text comprises indexing all the terms in a document. Optionally or alternatively, a part of the words or terms in a document is indexed. Optionally or additionally, common words such as ‘the’, ‘and’, ‘I’, ‘you’, ‘do’ and such, and/or connective words, are not indexed. Optionally or additionally, at least 20%, 50%, 70% of the words or roots are indexed. Optionally, common words are responsive to the geographical zone, e.g. ‘London’ would be common in the UK. Optionally or alternatively, terms are indexed responsive to frequency in the document. Optionally or additionally, common words are not included in the frequency ordering.

In exemplary embodiments of the invention, limiting the size of an index stored on a peer allows to replicate an index from one peer into another in addition to an existing index for a term. The replication enables one peer to store an index for a term that is stored also on another peer, potentially enlarging the redundancy and/or durability of the system. For example, peer 102a stores a term-index 240 for term 212a and also a term-index for term 212b. Optionally and alternatively, only part of an index is replicated.

Optionally, the peer limit for the number of index entries 204 in peer-index 202, or the number of entries 204 for each term in term-index, is small relative to the capacity of the device and/or the available capacity of peer 102. It should be noted that the capacity of the device such as cellular phone may be small relative to other devices such as a personal computer.

Optionally, all peers have a common limit. Optionally or alternatively, each peer or a group of peers or a type of peers has its own particular limit. Optionally, peers get a limit responsive to the cost of contacting them, so that higher communication cost to a peer may effect increasing its limit so in one contact many entries 204 of term-index 240 maybe consulted. Optionally peers may get a limit responsive to other characteristic such as related to cooperation. For example, a peer that is willing to share documents at no cost, or low cost, may get a low limit and spare more resources and vice versa.

Optionally, the limit is related to the device and/or the system operation and/or the system performance and/or the system constraints and/or the number of peers and/or the number or the relative popularity of instances of terms 212. Optionally, the limit is set due to other factors, for example, the number or size of the documents. Optionally, the limit is determined due to other factors such as experience or simulations.

Optionally, the limit is much smaller than the number, or the expected number, of documents, in the system. Optionally, it is substantially smaller. Optionally, the limit is of the same order as the number, or expected number, of documents in the system. For example, the limit may be 70%, 20%, 10%, 1% 0.1%, 0.01% or smaller, intermediate or larger percentages of the number of documents.

A low limit may, on one hand, reduce traffic between peers 102 for locating term-index 240 for a particular term 212, but on the other hand, may require contacting more peers 102 to find terms 212.

In exemplary embodiments of the invention, limiting the size of peer-index 202 or term-index 240 may contribute to the performance of peers 102 since it may consume only a part of their limited resources, such as memory. With a limited index size peer 102 may maintain its regular operation and allows resources for operations like search.

In exemplary embodiments of the invention, the limit may change responsive to the system operation. For example, a certain limit was set (e.g. for all peers 102) and after some operation time it turns out that locating terms requires more index entries and/or consumes too much time, and more cost than was expected or can be tolerated. As a result, the limit may be enlarged so that fewer peers would be needed to locate terms.

In exemplary embodiments of the invention, the limit affects the number of results that can be obtained from the peer's system. For example, assuming that a term-index of each term is stored in one peer. Using a structured search to find an initial sub-set of peers pertaining to one term will not typically exceed the number of entries in a term-index. Then, in order to enlarge or reduce the potential number of results in queries, the limit can be adjusted respectively. Optionally or additionally, a peer may realize that consistently fewer results are obtained than expected (or pre-determined, for example, by user request or setting) and conclude or assume that the limit is the cause, and notify the system (other peers) to enlarge the limit responsive to its search performance. Searching is discussed below in greater detail.

Optionally, the limit effects substantial balance of the load on peers 102 so that one or some peers may not be overloaded, or optionally, may not store large instances of common words that so that search operation may be hampered since these terms might be concentrated on a few peers.

Limiting the size of term-index 102 in peer 102 optionally contributes to other related benefits: (a) the traffic volume in searches and, optionally, other processes, is limited and so is the cost, which may be responsive to time, and/or volume of data, (b) the bandwidth is conserved, and (c) energy (battery life) is conserved.

In exemplary embodiments of the invention, limiting the size of a peer-index 204 stored on peer 102 reduces the effect due to a missing peer, since the amount of missing data is limited. The limited missing data possibly allows lowering the obligation to remedy the system, which may reduce the remedy traffic and cost and bandwidth utilization and/or may increase reliability.

In exemplary embodiments of the invention, the limited size of term-index 240 is at the expense of non-indexed terms 212 instances, which are discarded. Optionally, terms 212 that appear in, or associated with, source document 210 more than once may be discarded in favor of indexing of terms 212 that appear only once.

Optionally, terms 212 are indexed in term-index 240 (or discarded) according to a priority or importance of term 212, denoted as rating (see below).

Note that discarded terms may still be found by an unstructured search, and if they are frequent, optionally without incurring undue cost as discussed later on.

In exemplary embodiments of the invention, since the limit on the size of term-index 240 may reduce the extent of indexing, peers 102 maintain a counter for terms that were not indexed, substantially maintaining the integrity of the number of terms in the system.

Some examples on effects of limiting the size of term-index 240 are given later on in discussing some simulations results.

### Rating

A rating, optionally, relates to characteristics of terms 212 and/or a document, for example one or more:

(a) the significance or importance of term 212 in document 210 (e.g. a last name of a performer may be more significant than the first name),

(b) the frequency of term 212 in document 210,

(c) previous searches for term 212 in network 104,

(d) estimations of the frequency of terms 212 in the system, for example, relating to popular documents such as hit music or movies,

or (e) the age of a term or a document (e.g., so that new terms are more significant than old ones).

A rating may optionally comprise a weighted combination of the listed characteristics and/or others characteristics that contribute to a preference of a term 212 over another term 212. Optionally, the rating is applied when storing term indexes. Alternatively or additionally, the rating is applied when searching

### Publishing

Generally, publishing comprises of (a) peer 102 notifying the peers' system about its documents 210 and terms 212 they contain, or associated with, and (b) effecting a construction or update of term-indexes 240 on peers 102 for those terms. The following describes an exemplary publication (and later, un-publication) method. Others may be provided as well.

In exemplary embodiments of the invention, peer 102 (source peer) determines to which peer or peers 102 (destination peer) it may or can publish at least part of terms 212. Optionally or additionally, peer 102 records the identifications of the destination peers for later reference, such as for un-publishing (see later).

In exemplary embodiments of the invention, the destination peers are determined by locating peers 102 that store term-indexes for terms 212, optionally peers that still have room in their respective term-indexes. If none found, a peer for a new term-index is optionally chosen. For example, a peer that does not hold any index or a pear that holds small index and has enough capacity for additional index. Optionally or additionally, candidate peers for a new term-index may be picked by the system operation, for example, if that peer did not participate in the communications for a long time or just joined the network.

The candidate peers (for old or new terms) may be found by the system organization such as Chord, such as by a Chord successor, for a new term-index. Optionally or alternatively, a peer may be chosen according to a list or database on a server.

It should be noted that using an organization like Chord, the time, and related cost, is of the order of M×log₂N, where M is the number of published terms and N is the number of peers in the system. Assuming, for example, 10,000 peers and 10 terms, then approximately 10×15=150 steps between peers are required.

Optionally, the source stores the identification of destination peers for later use such as for un-publishing.

In exemplary embodiments of the invention, an identification of the publishing device is published, e.g. as Chord key or registration id in a server list or database. Optionally, other mapping or other information regarding the organization of peers 102 in network 104 is published. For example, source peer 102 may publish terms 212 to several destinations, and it publishes also the list of destination peers identification so they comprise a group related to this term, so that when one such peer is contacted for that term 212, the locator may skip the other peers in the group, reducing cost and time. Optionally or alternatively, a group may comprise of a number of Chord's succeeding peers. Optionally or alternatively, a group may be based on a list or database of peers on a server.

In exemplary embodiments of the invention, peer 102 publishes at least a part of terms 212 from at least part of documents 210 it stores or may access, to at least one of other peers 102 for their respective term-indexes 240. Optionally and additionally, publishing comprises providing identification data, or a link, to a document where term 212 appears or associated such as by tagging, optionally with the location or locations of terms 212 in documents 210 that source peer 210 stores or may access.

Optionally or alternatively, terms 212 from document 210 are stemmed and only the roots of the terms are published.

Optionally or additionally, publishing provides other information. For example, the number of appearance of a term in document 210 or the number of documents 210 peer 102 stores or can access. This information may be useful in for the system operation such as in determining a search strategy or for churning remedy.

Optionally, the rating (as discussed above) for term 212 is also published, which may take part in ranking results such as significant result or a trivial one.

Optionally, publishing comprises providing the frequency of terms in a document. Optionally and additionally, the frequencies of common words, if published, are not provided. Optionally or alternatively, publishing comprises providing estimates of frequency of terms in the system.

### Publishing Order

In exemplary embodiments of the invention, the source publishes terms 212 aiming to effect indexing of high rated terms 212 on the expense of low rated terms 212.

Optionally and additionally, the source is aware of or assumes the storage and indexing procedure in the destination peer. Based on the information, the source publishes terms to match the destination peer procedures, aiming to save time, energy consumption or other resources of the source and/or destination peer.

For example, the source is aware that the destination peer stores terms in the limited term-index in the order of the terms arrival. Therefore, it may sort the terms by a rating and publish the terms in an order so that high rated terms are published before low rated terms. Optionally or alternatively, if the source suspects, or assumes, that the communication with the destination, and/or the operation of the destination, are not reliable, it may randomize the sorted terms to some degree so that, statistically, a greater (or sufficient) proportion of high rated terms are indexed than low rated terms.

Optionally or alternatively, if the source peer lacks information regarding the storage procedure of a destination peer, it may assume the simplest first-in-first-stored, or it may use a random order of publishing to achieve some statistical distribution of indexed terms. Alternatively or additionally, the source peer may switch between one or more publishing order tactics to achieve some statistical distribution of indexed terms and/or risk.

Optionally, the source peer stores terms 212 for later use (such as for un-publishing). Source may store the terms locally or on certain peers 102 or other devices such as a server. Optionally or alternatively, the source stores only a portion of the published terms, for example, only the high rated terms.

In exemplary embodiments of the invention, peer 102 publishes upon joining network 104. Optionally or additionally, peer 102 updates other peers 102 responsive to new documents 210 it obtains. Optionally or additionally, peer 102 updates other peers 102 on a periodic basis, the period optionally related to cost programs such as at night.

### Publishing Example

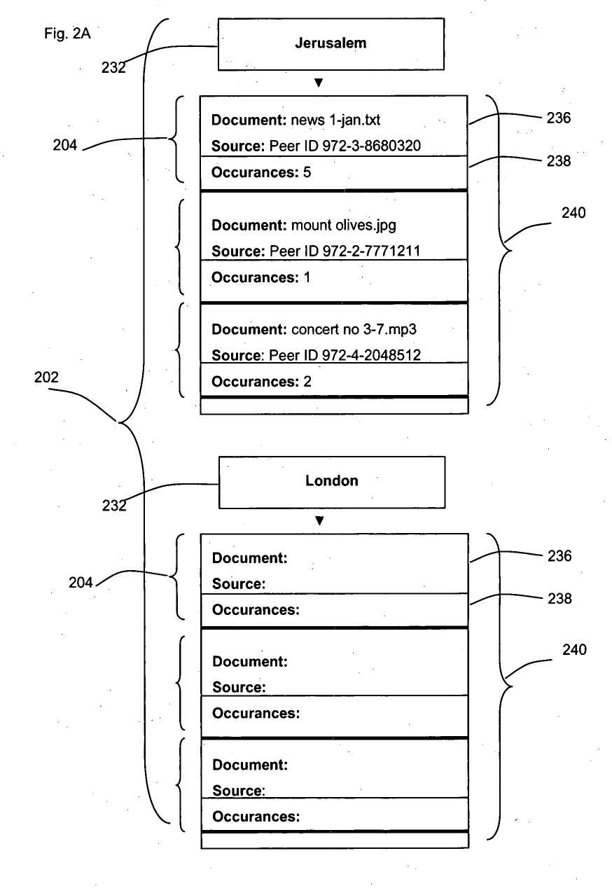

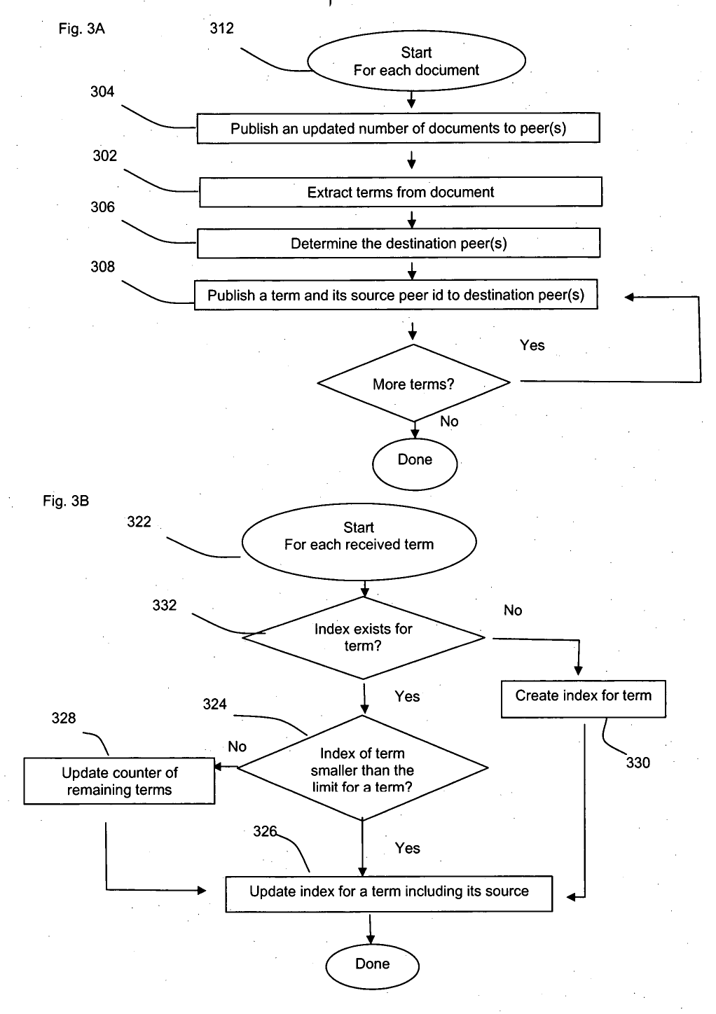

FIG. 3A is a flowchart of publishing terms in a document from a source peer to a destination peer, in accordance with an exemplary embodiment of the invention.

As a complementary action for publishing, the source peer updates the global count of documents in the system (described above). The publishing peer (‘source’) queries the specific peer or peers that maintain the total count of documents in the system, updates the count by the number of documents it publishes, and publishes the updated count to that specific peer or peers (304).

As a preliminary action, for each document the peer intends to publish (312), it extracts from the document the terms for publishing (302). Optionally and additionally, the terms comprise stemmed words.

In order to publish, the source determines, as described above, which peer or peers are to receive the terms (‘destination’) (306). Then, for each document, it sends (using the network resources such as by SMS) the terms to the destination peer or peers (308). Typically, it sends the identification of the source along with the term so that when an index is queried the source of the document may be located. Optionally and additionally, other information is sent such as the location of the term in the document.

It should be noted that the source may publish terms (and/or other information) to more than one destination peer, creating redundant term-indexes with optional benefits as described above.

FIG. 3B is a flowchart of publishing terms in a document at a receiving peer, in accordance with an exemplary embodiment of the invention.

Provided that operation of source peer and the communications are reliable, for each term that the source sent (308), the destination peer receives (322). Note that redundancy may repair effects of defective operation, as described above.

The peer-index of a received term is checked to see if a term-index exists for that term (332), and whether the number of entries is smaller than a limit that was defined for it (324). If so, the entry is added, comprising the term, source identification and optional other information that was sent (326). In case the limit has been reached already, the destination peer only records the count of the received terms. Optionally or alternatively, the destination peer records the number of terms exclusive of those that were indexed. Optionally or alternatively, if the received term has a better rating than any of the stored terms, the least rated term is dropped from the term-index and the new highly rated term is indexed.

In case a term-index for the received term does not exist yet, it optionally is created and then the information stored as above (330).

It should be noted that the source publishes terms irrespective if the destination has room for them or the index limit was reached.

Optionally or alternatively, the source may find out (query) if a destination does not have enough room and rout the terms to another destination. The destination may be a peer with a term-index below the respective limit, or if none found, a peer is chosen and a new term-index is created. Using an organization like Chord, the cost and time are related to the order of log₂N steps.

### Un-Publishing

Generally, un-publishing comprises of (a) peer 102 notifying the peers' system that it removes its documents 210 and terms 212 they contain, or associated with, (b) effecting the removal of term-indexes 240 on peers 102 for those terms, and (c) moving to other peers 102 term-indexes it might have store.

In exemplary embodiments of the invention, a peer un-publishes when a peer disconnects from the system in an orderly managed manner. Optionally, a peer merely notifies a different peer or a redundant peer that it is signing off and asks to have its documents and/or index removed in an organized manner.

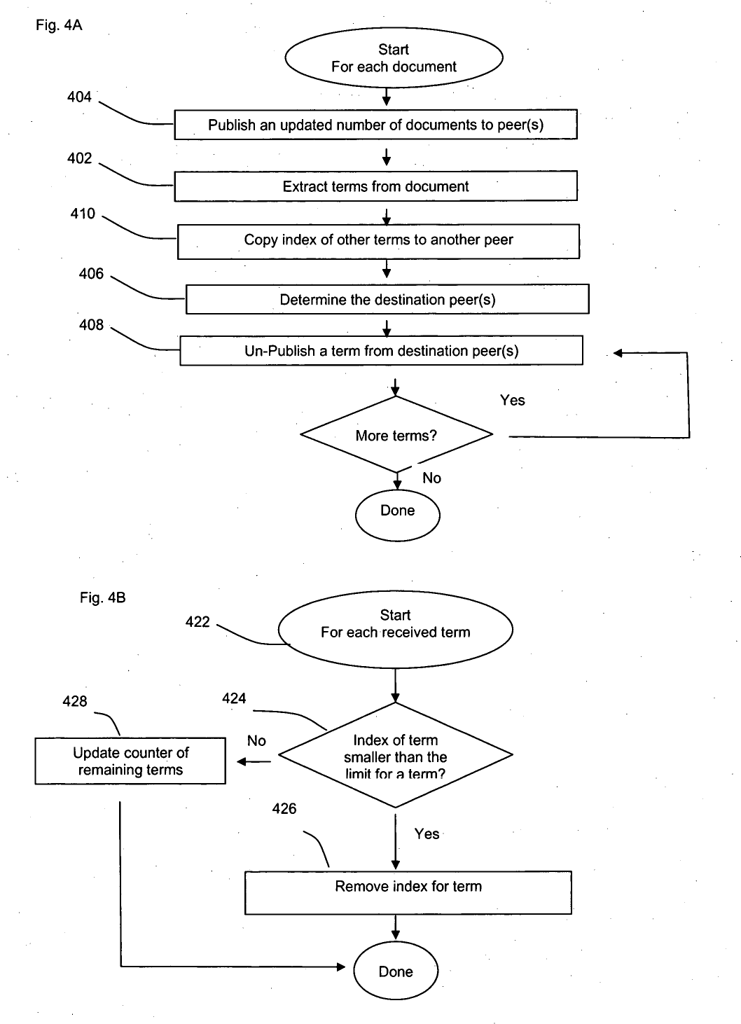

FIG. 4A is a flowchart of un-publishing terms in a document from a source peer to a destination peer, in accordance with an exemplary embodiment of the invention.

From the source (un-publishing) side, un-publishing is analogous to publishing but reversely, and will be discussed briefly in view of the publishing procedure.

As a complementary action, the source optionally updates the global count of documents in the system (described above) on those peer or peers that hold that count, subtracting the number of documents of the source (404).

The source peer extracts the terms from its documents (or use stored terms) (402).

Since the source may, as a peer in the system, store term-indexes of terms of documents related to other peer or peers, it sends a copy of the term-indexes of those terms to another destination (410). Optionally, the source sends parts of the term-indexes to more than one peer, so that the term-indexes of the destination would not overflow the limit. Optionally or alternatively, it may choose a peer similar to creating a new term-index in publishing.

In case the source is part of a redundant group for term-indexes it stores, it may not copy the term-indexes to another peer, or that action delegated to another peer in the group for later copy, but this may somewhat diminish the system robustness due to redundancy.

After the source secures the indexes of other documents, it optionally determines the destination peer that holds an index for the term of the source (406) and notifies them that the term is removed (408). Optionally the identification of the destination peers is determined as for publishing. Optionally or alternatively, they were stored and are ready.

FIG. 4B is a flowchart of un-publishing terms in a document at a receiving peer, in accordance with an exemplary embodiment of the invention.

Provided that operation of source peer and the communications are reliable, for each term that the source sent (408), the destination peer receives (422) and checks whether the term-index for that term is smaller than the limit. If so, it removes the term from its index (426), otherwise, it updates the count of remaining terms (428), that is, subtracts the count.

### Churn & Update

Churn is the random unmanaged disconnection of peers off the network or a suspension of communication. For example, peer 102 may withdraw, or disconnect, from network 104 momentarily or for longer time. For example, a busy status or a low signal may cause a momentary or short termed disconnection, while a power-off may cause a long time removal from the peers' system.

When peer 102 disconnects from the network 104 or suspends communication with other peers 102 without proper un-publishing, the system is disturbed. For example, if peer 102a found term 212a that is stored on peer 102c, it may look for it and counter a broken link it if peer 102c disconnected without a proper managed un-publishing.

In exemplary embodiments of the invention, the system performs actions to eliminate, or at least reduce, the effect of churn.

In exemplary embodiments of the invention, peer 102 is a part of a redundant indexes group in the organization of the system such as Chord. The system checks, or otherwise detects or assumes that a member of the group is missing.

A peer may detect, or suspect that a peer in a group is missing by recording time intervals of communications with that peer and if there is a significant silence time may assume it has disconnected. Likewise, when a peer encounters communications problems with a certain peer it can assume it has low signal with similar effect of disconnection (intermittent connection). The monitoring peer can be, for example, a random peer, a dedicated peer, a peer-group monitoring peer or each peer may have one or more peers assigned to monitor it periodically.

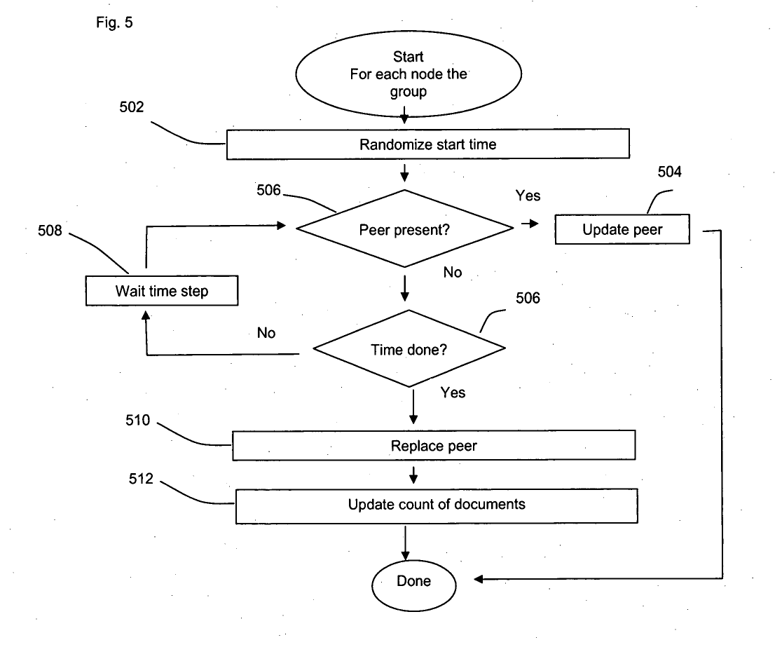

FIG. 5 is a flowchart of a remedy for a missing peer, in accordance with an exemplary embodiment of the invention.

A peer in the group (denoted ‘updating peer’), or optionally each peer, sets a random start time (502) to avoid collision with optional similar operations other peers.

Then the updating peer checks if a peer is present (denoted ‘suspect peer’), that is, connected back to the network (506). If so, it assumes that possibly the suspect peer might have missed a publishing, and therefore the updating peer updates the suspect peer (504).

Updating is similar to publishing where the updating peer queries others in the group for their term-indexes and publishes the term-indexes to the suspect peer.

If the suspect peer is missing, the updating peer waits a certain grace time and re-checks again for the suspect-peer, repeating the check until a timeout limit is reached (506). If the timeout limit has been reached, the updating peer decides that the suspect peer is off the network and replaces it (510).

Replacing optionally comprises adding a peer to the group like in publishing (using the peers' organization, such as Chord succeeding peer), and publishing to the added peer the indexes related to the suspect peer so that redundant group size is maintained. Additionally, the updating peer updates the global count of documents in the system (512). For example, if the publishing peer published the number of its documents to the destination, then the updating peer can adjust the global count of documents substantially accurately (up to communications or operation malfunction or peers). Optionally or alternatively, the number of documents of the suspect peers is estimated and the total number of documents becomes a close approximation (possibly effecting somewhat calculations such as term frequencies or cost estimations, as described later). Optionally, the number may be adjusted later, for example, during an idle time and/or low cost program, certain peers or devices may tour the system and determine the total number of document and update the global count. Optionally a server may update the document count, for example, on a periodic basis, upon low cost communication period, or due to other opportunities.

### Searching

Generally, searching begins with a peer, or any device on the system, that seeks a document or another object that is characterized by a term or terms associated with the document of object.

The peer seeking the object will be denoted as ‘requesting peer’.

The characterizing terms will be denoted as ‘query’ in general, and ‘query term’ or ‘query terms’ when particular term or terms are referred to.

For clarity and without compromising generality, documents comprising or associated with terms represent in the discussions any object for search matter, unless otherwise specified. Non-textual searches are discussed later on. A user may initiate the search by entering terms or the search may be requested by a peer function, such as an on-going process that tracks photographs of friends of a user.

The searches are described as AND searches, where other combination of AND/OR etc. are implied and discussed briefly below.

Generally, searching comprises of:

(a) finding out of peers storing term-indexes for one or more of the query terms,

(b) ‘intersecting’ the respective term-index entries so that all the query terms are related to the same document (matching, or finding), and

(c) providing the requesting peer with a link to the document.

(d) “OR” clauses are optionally implemented by performing parallel searches.

When there is a match between the query and a document, a link to the document is provided to the requesting peer. For example, the link comprises (a) the identification of the source peer having access to the document, and (b) an indication of the document itself, such as its file name, or a web URL, or a UNC (Universal Naming Convention) path if the source peer is connected to a network. Such a document may not be necessarily in electronic format, but rather, as a book, article, and/or non-document items such as a tool, medicine, service provider, business and such items or persons or organization that might be published in the system.

Alternatively or additionally, the document itself, or part thereof, is sent to the requesting peer. Optionally or additionally, a part of the document comprising at least one of the query terms is sent to the requesting peer.

In exemplary embodiments of the invention, providing a link to a document comprises indicating the geographical or proximity of a peer having access to the document. For example, the result may direct the requesting peer to a device or person that may deliver the document.

In exemplary embodiments of the invention, the query terms are words. Optionally, they are stems as described earlier. Optionally, documents terms are indexed as stems and the query terms match them according to a common stem.

In exemplary embodiments of the invention, peer 102 requests for one or more terms 212 in documents 210 so that it may obtain or access the respective document.

In exemplary embodiments of the invention, the search is a structured or unstructured search, or a combination of the two.

In exemplary embodiments of the invention, an unstructured search comprises contacting peers and checking documents they store or accessible to the peers. Optionally or additionally, a document is checked for at least one of the query term. Optionally or additionally, a document is checked for all the query terms (full match).

Alternatively or additionally, an unstructured search comprises contacting peers holding a term-index for a query term, and using the information of the index to locate peers that store or can access documents comprising the term.

In exemplary embodiments of the invention, structured search finds potential peer according to the system organization such as Chord by ˜log₂N steps or via a list or database in a server, and consults the term-indexes to find the document.

In exemplary embodiments of the invention, an unstructured search is used for common or abundant terms since there is a substantial probability to find, within a few steps, peers holding the respective term-index. On the other hand, a structured search is used for less frequent terms since, though it may be relatively costly, it requires few steps (e.g. log₂N in Chord).

Optionally, the searches types are selected to achieve substantial efficiency, for example, in terms of costs, where costs are not necessarily money but may be other criteria such as bandwidth utilization. Optionally, other factors effect the determination of the searches, such as the type and size of the query, the size of the data involved, number of peers or the organization of the system.

Optionally, unstructured searches are used when the expected cost is low. For example, when the unstructured search will terminate quickly, such as when the search terms are very frequent so that the probability to find a term is high.

Another example is when an unstructured search is used after a structured search to find the remaining common terms in term-indexes of less common terms (which were obtained by a structured search).

In exemplary embodiments of the invention, a TTL tag is used, indicating the maximal number of steps a peer may make to obtain a term, as each step decrements (or otherwise reduces, e.g., based on cost) the TTL value, until, eventually, it expires (zeroed).

Optionally, unstructured searches use a TTL tag, controlling the time and/or cost to obtain a term, on the expense of possibly missing a term-index (but presumably finding many before the TTL expires). Optionally, a TTL tag is used when the probability of finding a term is relatively low, or the cost of using the unstructured search is relatively high (relative to structured search and/or to clear-cut conditions). Yet, optionally, a TTL tag is not used at all.

In exemplary embodiments of the invention, a search terminates successfully if at least one document is found. Optionally and additionally, a search is considered successful if all the documents in the peers' system are found (exhaustive search). Optionally, a search is considered as complete if a threshold count of documents (‘T’) is found even if not all peers 102 and term-indexes 240 where consulted.

Optionally or alternatively, a search is considered as incomplete, or a fail, if the minimal number T of documents is not reached.

Optionally, the search is considered complete if the threshold count T includes highly rated documents, for example, fashionable pop music relative to news clips. Optionally, the preference attributes are provided along with the query.

In exemplary embodiments of the invention, when the system comprises portable devices such as cellular phones, a search may be considered satisfactory (and complete) if less than the minimal number T of documents are found. Optionally or alternatively, a document may be considered as found if it does not comprise all the query terms (partial match). Alternatively or additionally, to be considered as found in a partial match, the document should comprise at least one highly rated term.

It should be noted, as described before, that the search threshold T might be effected by the limit of term-index 240 size.

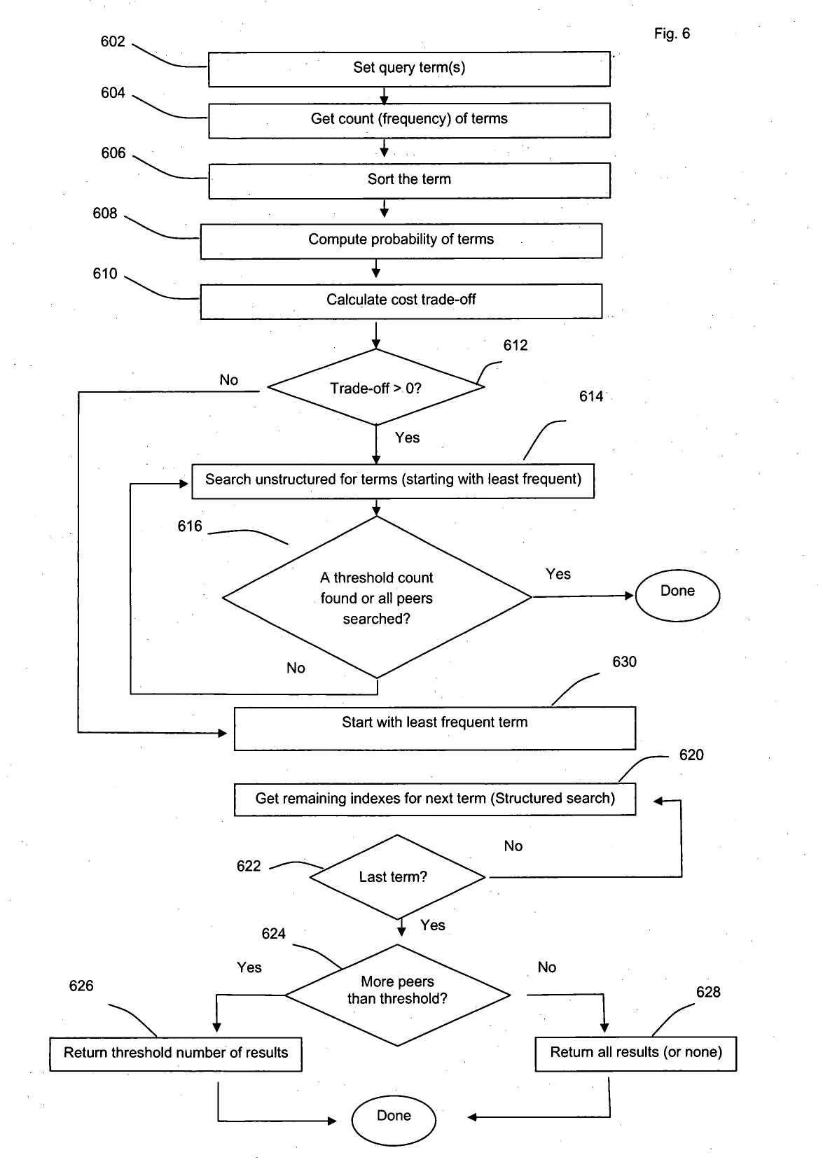

FIG. 6 is a flowchart of a search combining structured and unstructured search, in accordance with an exemplary embodiment of the invention.

The requesting peer sets the query terms (602) and determines the count of each of the query terms (604). For example, since in publishing the destination recorded the count of terms that were published, the requesting peer conducts a structured search and gathers the count of each query term (it is optionally faster and cheaper than retrieving the term-indexes, which otherwise may comprise the search itself).

Optionally, the count is normalized by dividing it by the global number of documents in the system, obtaining the relative frequency of each term. The query terms count, or frequency, is optionally used in selecting between structured and unstructured searches. Optionally, the count is provided by a stand alone server, as noted above.

In exemplary embodiments of the invention, the queries and their count, optionally with the number of documents found for each, are stored, or cached, on specific location(s) such as specific peer or peers, or on a server. The frequency of terms may be estimated, or the popularity for that end, based on previous searches so there is no need to look around the system for the terms count (saving time and cost).

Having the count of each query term, the requesting peer orders the terms by frequency, least frequent first (606). Then the requesting peer computes the probabilities of the terms, for example, by multiplying the frequency of each term (610). Optionally, the probabilities of query terms are estimated otherwise, for example, using methods based on past searches and/or heuristics. Such other methods may be useful in coping with cases such as the probability of finding a term combination like ‘new york’ is likely to be higher than the product of frequency of the individual terms ‘new’ and ‘york’. For example, past queries and respective results may show that ‘new york’ frequency is higher than the product or frequencies of ‘new’ and ‘york’.

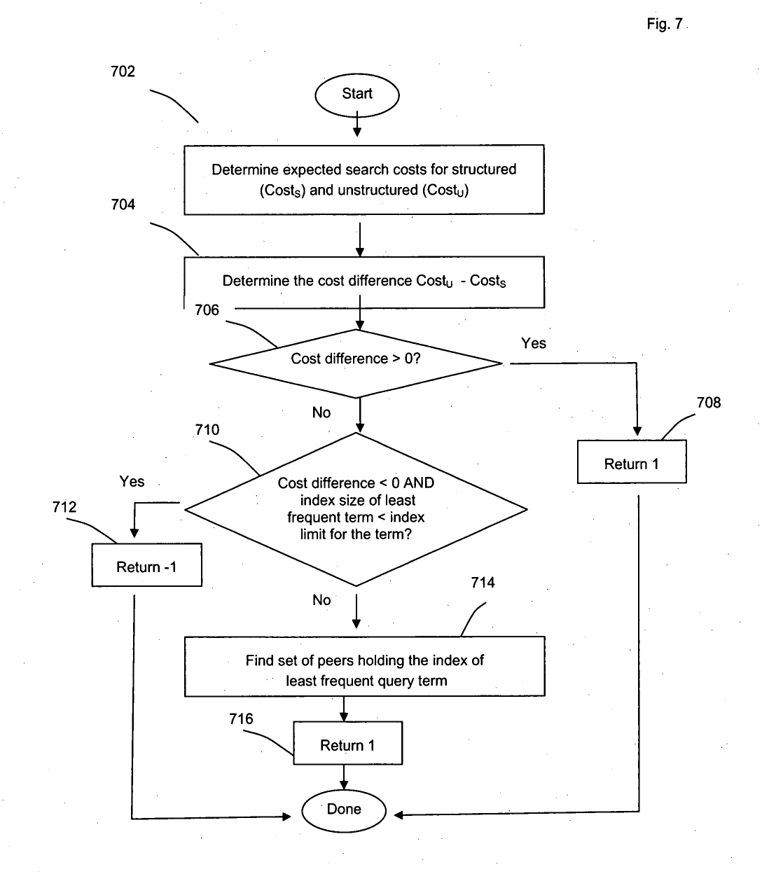

Before starting the search, a cost tradeoff is calculated (612) that returns arbitrary code values as selectors for the search strategy. An example for a cost tradeoff calculation is given in FIG. 7 below.

If the tradeoff selector value is larger then zero, an unstructured search is started, beginning with the least frequent term (614), until a T count of documents is found or all peers were searched. It should be noted that though less frequent terms are searched by unstructured search the tradeoff may still be favorable.

If the tradeoff selector value is less or equal zero, a structured search is conducted for each query term (620). A term or terms are searched based on the system organization, finding the respective term-indexes.

In case of a multi term query the first term is the least frequent (630), with respective term-index, or term-indexes, of minimal size.

The minimal size is due to the fact that least frequent terms in documents define a small set of candidate documents, while common (frequent) terms define a large set of candidate document. It is more cost effective to start with a small candidate set rather than a large on.

For example, a document comprising ‘rock’, ‘dance’ and ‘winter’, it is likely that ‘rock’ and ‘dance’ will be part of many documents, so there is not much sense looking for them, but, rather, start with documents that hold ‘winter’, and in those look for the other terms. For example, intersecting indexes of ‘dance’ with those of ‘winter’ will yield documents comprising ‘dance’ and ‘winter’, and so on.

In searching for the term-indexes of the next query term item, the term-index, or indexes, of the least frequent item is used as basis (620). Optionally, the set of peers holding the term-indexes of the least frequent term is returned by the tradeoff procedure described later on (with respect to FIG. 7).

Finding a term-index of the next term, it is intersected with the previous one, and so forth, until the term-indexes of the last terms are obtained (622), converging to term-indexes for documents in which all the query terms appear. If the number documents is larger than the threshold T (624) then only T number of results is returned (626). Otherwise, any results obtained so far, or none if no document was found, are returned.

It should be emphasized that once peers holding the term-indexes for the least frequent terms are identified, further searches are optionally performed only on those peers or indexes. Because a document comprising all the terms, including the least frequent ones (terms intersection), peers that do not store term-indexes for the least common term are not relevant (at least for a full match). Furthermore, being the least frequent, the sub-set of peers and the indexes holding the least common terms comprise a substantially minimal set of candidates for the queried documents.

In exemplary embodiments of the invention, as a peer is contacted for a term-index of query terms, that peer performs the intersection and forwards the intersected indexes, or the relevant entries in the intersected indexes to another peer, according to the system organization. The results may be returned back along the search path of the peers, or information about the requesting peer is provided along the way so that the results may be provided directly to the requesting peer.

Optionally or alternatively, entries of the intersected term-indexes are sent back to the requesting peer, which sends it to another peer for further intersection with the next term in the query, and so forth.

In exemplary embodiments of the invention, the requesting peer obtains the term-indexes of for each term and performs the intersection of all the query terms on the index entries. Optionally, the requesting peer does part of the intersection and the other peers do the rest, and the requesting peer performs the final intersection.

In exemplary embodiments of the invention, the search actions as described above may switch between using structured and unstructured searches midway through processing the query terms.

Optionally, once the algorithm notes that an unstructured search is cheaper it immediately uses this approach, and looks for all remaining terms simultaneously. Optionally or additionally, during the structured search, the algorithm iteratively re-evaluates if the structured search should be continued, or if to switch to unstructured search. For example, assume a multi term query contains several common and uncommon terms. The algorithm may first use a structured search to find term-indexes of infrequent terms and obtain the intersection of the indexes to create a list of index entries and their respective peers' identifications. The algorithm may then switch to using unstructured search within the list of peers to find the term-indexes of remaining common terms.

In exemplary embodiments of the invention, at least part of the search activities may be conducted in parallel. For example, unstructured searches may be started in parallel for each of the common query terms, and that optionally, in parallel with the structured search for least common term. Optionally parallel operations are started responsive to cost or efficiency consideration such as bandwidth utilization.

In exemplary embodiments of the invention, the threshold T for number of results is much smaller than the number, or expected number, of documents in the system. Optionally or alternatively, it is substantially smaller. Optionally or alternatively, the threshold T is of the same order as the number, or expected number, of documents, in the system.

In exemplary embodiments of the invention, the requesting peer defines the value of the threshold T. Optionally and additionally, the peer defines also attributes for documents that are relevant to be included in the count T.

In exemplary embodiments of the invention, a search query comprises non-textual attributes such as proximity of peers. In such a case, the query comprises a value such as the maximal distance requested. The requesting peer searches the peers' system similarly to textual searches, but inquiring on the non-textual parameter. Such parameters may be deduced ad-hoc (e.g. at the contacted peer or via the network services). Optionally, the query comprises of textual and non-textual terms, for example, documents containing ‘rock dance’ within 1 kilometer.

In exemplary embodiments of the invention, a structured search and unstructured search may be conducted run in parallel due to query form a requesting peer. For example, the search that finished earlier provides its results to be intersected with the results of the other one. Optionally or additionally, the searches may be tuned so that the search for infrequent term (probably an unstructured search) will, on average, finish before the search for frequent terms to exploit the basic sub-set of peers storing infrequent terms as discussed above.

In exemplary embodiments of the invention, a plurality of searches may be conducted in parallel such that a requesting peer provides indexes for another requesting peer.

In exemplary embodiments of the invention, an OR query may be used. Optionally, the query is parsed to OR'ed query terms, and each such query is requested separately. Optionally or additionally, the separate queries may be conducted, at least partially, in parallel.

In exemplary embodiments of the invention, a NOT query may be used, so that if a NOT'ed term is found, the respective document is ignored.

In exemplary embodiments of the invention, a ‘wildcard’ symbol representing a plurality of terms or part of terms may be used. Optionally, if the wildcard symbol stands for a full term (or root, if terms are stemmed), then it may be ignored in the query since the intersection of the other terms characterizes the documents. Alternatively or additionally, if the wildcard stands for a part of a term, then the system is searched for terms comprising the explicit part of the term.

In exemplary embodiments of the invention, wildcard may be used in AND and/or OR and/or NOT queries as described above.

In exemplary embodiments of the invention, the parsing of a query terms due to, for example, an OR phrase of wildcard, may be preformed either at the requesting peer and/or the peers contacted for their indexes. Likewise, the division to sub-queries as described above may be performed at either the requesting peer and/or the peers contacted for their indexes.

The decision regarding the location of carrying out of parsing and division of queries is performed may be responsive to cost estimation and load on the peers. For example, a peer with very limited resources such as low battery, may delegate the task to another peer, even on the expense of extra communications costs.

### Revenue (General Discussion)

Communications, typically, are not free of charge. Likewise, a peer (and generally a person possessing or controlling the peer device) typically does not wish to donate resources such as memory space, bandwidth and energy. These issues are even more acute in portable devices and more so in cellular phones with their limited resources and costly communications.

Typically, a peer should have a motivation to participate in the peer's system for storing indexes and sharing documents. One such motivation may be an opportunity to get revenue or other assets such as obtaining documents.

The telephone manufacturer may wish to raise revenues by supplying the capabilities and software modules for the peer devices to participate in the system.

Alternatively or additionally, the cellular telephone company, which provides the communications infrastructure and message forwarding services, may wish to take part in the revenues as well.

To facilitate the peers' system operation, motivations and revenues opportunities optionally form an integral part of the methods and system.

For example, a peer may dedicate some of its (possibly scarce) memory capacity to store term-indexes 240 of documents 210 terms 212 if it obtains some revenue. For example, for each document that was found due to the index it stores, it gets some payment or refund it its cellular company account. Optionally or additionally, the payment may be responsive to the rating or size of the term or document. The payment may be obtained from the requesting peer via its cellular company account. As noted above, payment may be in like, or in non-money benefits.

Optionally or additionally, a peer may dedicate a larger size of index responsive to the rate of payment it obtains for its resources usage.

In the other end, the cellular company, either that of the requesting peer or the peer providing the index, may charge a percentage of payments so that it has a motivation to supply the services for message forwarding.

Optionally or additionally, a cellular company may supply a server for peers' organization (e.g. a list or database) and/or caching of operational data such as query and results history (as discussed before). For this service the company may charge a payment for each message or for a volume of messages used in the system (e.g. charging the accounts of the respective participants of the messages).

Since a cellular company may profit from the system operation, it may compensate peers who use the system extensively relative to other peers by allowing them benefits, such as broader bandwidth or reduced charges, to motivate them to use the system (and pay the company).

When a peer allocating resources for the system operation (e.g. index space, message routing) obtains revenue, it may wish to increase revenue. The provider may give it (e.g. by downloading) software versions that allow larger memory capacity for indexes and/or processor time allocation, in return for a payment or participation in the revenues.

Optionally or additionally, a peer providing a document (e.g. by sending it) may charge the recipient (e.g. the requesting peer) for the service. The charge may be, for example, by crediting the sender's cellular account, or by providing indexing space for the sender's document, or by providing the sender with a document.

Since the cellular company profits from the system operation, it may enhance it by providing more services, possibly for a charge. For example, it may provide locality information so that the requesting peer may query (optionally in addition to textual queries) about the locality of provider of documents so that it may obtain the document from close by peers for less expensive communications (e.g. without roaming).

In exemplary embodiments of the invention, a peer may donate, to some extent at least, resources such as memory capacity and performance free of charge. Optionally, the will is due to motivate others to do so. Optionally or alternatively, it may do so when communication cost is low such as at night or weekend. Optionally or alternatively, it may donate resources until some overhead level, beyond which it may charge. Optionally or additionally, the charge may be responsive to the overhead, the higher the overhead, the higher the price. Optionally or alternatively, beyond a certain overhead no extra charge is demanded.

In exemplary embodiments of the invention, a peer may change the limit it allows on stored index size responsive to the communications costs. For example, if night rate is low the limit will increase. Alternatively or additionally, the limit is responsive to the load the user encounters during searches so that the lower the cost the higher the limit.

In exemplary embodiments of the invention, a peer may donate more resources responsive to its level of querying and obtaining information and/or documents.

In exemplary embodiments of the invention, a peer may reserve resources such as memory for indexes in at least two partitions, where each partition has a different price tag. Optionally or additionally, one partition is free of charge, for example, to motivate others to do donate some resources for the benefit of the peers' system.

In exemplary embodiments of the invention, some peers may be connected to the system for a long time relative to others. The more permanent peers may encounter more traffic for consulting indexes that they may store, as well as requests for documents sharing. Such peers may, due to cost consideration and performance overhead ignores incoming traffic, effecting possibly some degradation of the system performance. Alternatively or additionally, such peers may yield to incoming traffic possibly, if extra charge is paid.

In exemplary embodiments of the invention, the more permanent a peer is in the system, the demand to duplicate its term-index entries is reduced since it is available for a substantial time periods. Conversely, intermittent peers may demand a larger extend of redundancy for their term-index due to the irregularity of their connection times.

In exemplary embodiments of the invention, a peer device, such as a cellular phone comprises facilities to control and limit the usage of resource for searching. For example, to limit an index size, or to limit CPU time allocation, or bandwidth usage.

Optionally, the control is by a software module or modules that use the memory and/or CPU and/or hardware of the cellular phone. Alternatively or additionally, add-on units are used which, in addition to the software code comprise of hardware, possibly with an extra CPU. In either case the software may use existing or add-on firmware. Alternatively or additionally, the software is coded in the firmware.

Optionally or additionally, the software may be used to calculate costs, present and past, of using the phones, optionally and additionally respective to issues such as a particular use (query, index lookup) and respective to available resources, payment program and geographical locations.

In exemplary embodiments of the invention, the system comprises of peers connected to different provides or networks.

In exemplary embodiments of the invention, the peers in the system may be grouped according to some common character such as geographic location and/or demographic criteria of the users and/or based on analysis of usage characteristics (e.g., terms used in documents, documents typically accessed). Optionally or additionally, groups may overlap.

In exemplary embodiments of the invention, for example, in order to save costs, when a requesting peer inquire the system about terms count, the consulted peer may send links to the respective documents. Such an approach may be cost effective for short replies such as when the query refers to just a few documents.

In exemplary embodiments of the invention, a search may be incremental.

One option is providing links to documents that match a sub-set of the query terms (partial match), optionally responsive to the term frequency, and continue to provide documents that more fully match the query.

Alternatively or additionally, a search is incremental as some documents are provided, and the search continues to locate and provide more documents. Optionally or additionally, the initial result documents are sent responsive to the frequency of terms associated with the documents, optionally terms that are not part of the query.

In an exemplary embodiment of the invention, a user can view the search results as they increase and/or change order.

The revenue issues and consideration as exemplified above may, therefore, affect the indexes sizes and indexes distribution and redundancies among peers.

### Cost Estimation and Tradeoff

As discussed before, searches require stepping between peers to consult their term-indexes and obtaining documents. Stepping between peers typically comprises contacting a peer and transferring messages.

In cellular phones the cost of communications may be a significant cost factor.

The present invention uses, when appropriate, a hybrid search, namely, a combination of structured and unstructured searches. As noted above other parameters of the search, such as expected quality and expected number of answer may also interact with cost and with system limitations.

To determine when, and to what extent, each search type is used, a cost tradeoff (e.g. communication costs) that aims to minimize the cost may be useful.

It should be noted that an unstructured search appears to be efficient for common search terms respective to a structured search, and vice versa.

The following discussion elaborates to some extent an approach to cost evaluation and tradeoff determination.

Cost formulas

In exemplary embodiments of the invention, the number of steps expected for finding a term by unstructured search is given by equation (1) below.

S_{U}=T/P(term) (1)

where S_{U} is the number of steps, T is the threshold T, and P(term) is the probability of query term term as discussed in the publishing section

Assuming a cost C_{U} per step, the cost Cost_{U} of finding T results for a term, Cost_{U} is given by equation (2) below.

Cost_{U}=C_{U}×S_{U}=C_{U}×T/P(term) (2)

In exemplary embodiments of the invention, the number of index entries associated with a document (ignoring redundancy) does not exceed the number of entries of the least frequent term (as discussed above). Consequently, the number of entries of the least frequent term comprises a minimally necessary set of terms for a search, so that the number of entries sent in a structured search may be bounded by the entries of the least frequent term.

Therefore, the number of index entries sent in a structured search is given by equation (3) below.

E_{S}=(n−1)×Count(term_{if}) (3)

where n is the number of query terms, E_{S} is the number of query items, and Count (term_{if}) is the number of index entries for term_{if}, which is the least frequent term.

It should be noted that (n−1) is used rather than n since, after finding the intersection of indexes of (n−1) terms, no more intersections of term-indexes have to be forwarded or requested as the one that received the result of (n−1) intersections can do the last (n^{th}) intersection locally.

Assuming a cost C_{S} per sending an index entry, the cost for sending the index entries for query terms combination, Costs, is given by equation (4) below.

Cost_{S}=C_{S}×E_{S}=C_{S}×(n−1)×Count(term_{if}) (4)

In exemplary embodiments of the invention, the values of C_{U} and C_{S} are close and, for convenience, are normalized to approximately 1.

Applying the equations (3) and (5) for a frequent term (or terms), which may appear in a majority of documents, yields that the cost Costs of searching by structured search, is given by equation (5) below.

Cost_{S}=C_{S}×(n−1)×Count(term_{f})≈C_{S}×N≈N (5)

where N is the number of document in the system and term_{f} is a frequent term in this example.

Namely, for frequent terms the cost of a structured search is of the order of number of documents in the system.

As unstructured search is concerned, since the probability of a frequent term (or terms) is high, it may be approximated to 1, so that the cost Cost_{U} of finding a frequent term by an unstructured search is, based on equation (2), given by equation (6) below:

Cost_{U}=C_{U}×T/P(term_{f})≈1×T/1≈T (6)

Namely, for frequent terms the cost of an unstructured search is of the order of number of required number of results.

In exemplary embodiments of the invention, when an infrequent term (or terms) is queried, it may be found in few documents only, so that

w<<N (7)

where w is the number of documents in which the infrequent term is found, and N is the number, or expected number, of documents in the system.

Optionally, T is much smaller than the number or expected number, of documents in the system, so that

w≈<<N (8)

In such a case an unstructured might have to step around a substantial percentage of the peers to find the occasional documents holding the infrequent term. That is, the probability of a query term (or terms) is low, such that,

P(term_{if})≈w/N≈T/N (9)

where term_{if} is an infrequent term.

Therefore, by equation (2) and (9), the cost of unstructured search is given by

Cost_{U}=C_{U}×T/P(term_{if})≈T/(T/N)≈N (10)

Namely, for infrequent terms the cost of an unstructured search is of the order of the number of documents in the system.

As structured search is concerned with infrequent term (or terms), according to equation (4), the cost of finding it is given by equation (11) below.

Cost_{S}=(n−1)×Count(term_{if})=(n−1)×w≈(n−1)×T≈T (11)

Namely, for infrequent terms the cost of a structured search is of the order of number of required number of results.

It should be noted that some of the above assumptions, such as relative costs, depend on the implementation.

It should be noted that for queries involving only one term the structured search returns only the first T results, and even if the results include sending the entire term-index for a term, the cost of using structured searches is only about T. Therefore, in exemplary embodiments of the invention, optionally a structured search is a reasonable candidate for a single term query, even for infrequent terms.

To summarize, for frequent search terms the cost of unstructured search is substantially proportional to the search threshold T, while structured search is substantially proportional to the number of documents N. Conversely, for infrequent terms the cost of unstructured search is substantially proportional to the number of documents N, while structured search is substantially proportional to the search threshold T.

In exemplary embodiments of the invention, the cost C_{U} of an unstructured search step, and C_{S} for sending an index entry, are determined according to experiment, pilot test and/or substantially realistic simulations. Furthermore, the cost may change depending on characteristics such the distance between calling peers, an individual pear program and other factors such as night or weekend discounts. Alternatively or additionally, some statistical variation may be assumed so that, on an average, C_{U} and C_{S} may give favorable estimate of the costs.

It should be noted that the discussions, example, formulas and approximations above are given to represent an approach for cost estimation and not to present an only solution.

### Cost Tradeoff

FIG. 7 is a schematic overview of actions involved in determining a tradeoff of costs between structured and unstructured searches, in accordance to exemplary embodiments of the invention, and as related to action (612) in FIG. 6.

The expected costs of structured and unstructured search are determined as discussed above (702) and the difference of the costs of unstructured search and structured search is obtained (704).

In case the difference is larger than zero (706), a value of 1 is returned (708).

In case the difference is less than zero and the number of entries in the index of the least frequent term is less than the limit of that index (710), then −1 is returned (712). Otherwise, the set of peers holding indexes of the least common query terms are found (comprising the relevant set for the query, out of which other terms will be intersected) (714), and the set is returned with a value of 1 (716).

In exemplary embodiments of the invention, other tradeoff evaluations may be used. For example, depending on the number of peers in the system is not too large relative to the limit on index entries than only unstructured search may be indicated Another example is when the threshold T is of similar order of magnitude as the number of documents, structured search would be indicated.

In exemplary embodiments of the invention, when a term or terms are of medium frequency, heuristics and/or past performance may indicate the search tactics that potentially reduces the cost. For example, some arbitration or statistics methods such as random values may, eventually, limit the cost to some boundaries. Alternatively or additionally, if queries and results count are stored or cached, their analysis may indicate the search tactics, possibly responsive to the query size or nature (e.g. terms rating).

It should be noted that in exemplary embodiments of the invention, wireless devices and/or cellular phones comprise the peers and that communication costs and limited resources of the peer play an important factor in search tactics.

### Exemplary Results of Simulation

Table 1 displays the aggregated peers visited/index entries sent in finding 20 matches for each query (T=20) averaged over 1000 query pairs per query term frequency, using 75 as the limit of the index entries per term. The values represent a costs, assuming, for simplicity, that costs of visiting nodes through unstructured search, and sending entries of term-indexes in structured search, are equal, or C_{U}=C_{S}.

For simulation a two-term query was used with low frequency (L), medium frequency (M) and high frequency (H) terms. HH represents a query of two high frequency terms, LM represents a query of a low and medium frequency terms, and so forth.

The simulation confirmed, for example, that for frequent terms (HH) a structured search is more expensive (971,986) and an unstructured search is more effective (19,995), as expected. Conversely, the simulation confirmed that for infrequent terms (LL) an unstructured search is more expensive (2,000,000) in finding frequent terms and a structured search is more effective (1,466). In these extreme cases, the hybrid search yielded the effective results due to the cost tradeoff the respective effective search type was used.

Yet, where intermediate frequency terms are concerned (MM), the hybrid search in accordance with exemplary embodiments of the present invention, a better result was achieved relative to each of the search types (13,256 vs. 20,732 and 1,865,474). For mixed terms (LM, LH, MH) a similar trend is shown where the hybrid search yields better results relative to separate search types.

TABLE 1
Comparing cost levels of structured search (SS), unstructured search (US)
and Hybrid methods for a two term query of different frequencies.

| | SS | US | Hybrid |
|---|---|---|---|
| LL | 1,466 | 2,000,000 | 1,466 |
| LM | 2,.206 | 2,000,000 | 2,142 |
| LH | 3,177 | 1,987,754 | 2,010 |
| MM | 20,732 | 1,865,474 | 13,256 |
| MH | 60,188 | 234,211 | 18,075 |
| HH | 871,986 | 19,746 | 19,995 |

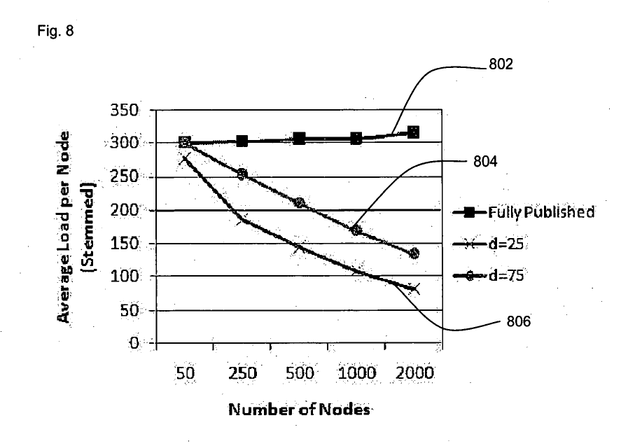

FIG. 8 schematically illustrates how the number of index entries per peer (load) is effected by the size of a term-index and the available number of peers, in accordance with an exemplary embodiment of the invention.

When no limit is imposed on the size of an index (fully published) the load is approximately constant and maximal (802).

As a limit is imposed, the load decreases with the number of peers, as the terms are stored on more peers.

The dependency on the index size limit is revealed by comparing a limit of 75 (814) and 25 (806). The smaller the limit the smaller is the load since the small limit does not allow terms to be index beyond the index limit and they are discarded.

As the number of peers increase, the load per peer decreases as more space is available to store terms, even with a limited index size limit.

### Exemplary Resources of Cellular Phones

In exemplary embodiments of the invention, cellular phones are used as the peers.

Typically, cellular phones have limited resources. Following are typical numbers, which are expected to get better as technology improves. For example, memory is typically in range of a 16-128 KB of RAM and 1-50 MB or storable memory. Some phones allow optional additional memory cards to increases the capacity (e.g., 1-4 GB) but the access time is can be longer than the regular memory, so it may affect the performance and consumes more battery resources.

The processor in cellular phones is typically a low performance RISC or other architecture, designed to preserve the battery life on expense of performance.

In many telephones, very low resources are available during a telephone conversation or during a media capture operation, to carry out other tasks.

Battery life is typically less than 48 and less then 24 or even 12 hours in regularly used telephones.

The communication bandwidth is typically several hundreds of thousands of bits per second up to 1-3 millions of bits per second. For lower grade telephones, the transmission rate may be in the tens of thousands of bits per second. Also, significant delay times may exist.

### General

In the description and claims of the present application, each of the verbs “comprise”, “include” and “have” as well as any conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to necessarily limit the scope of the invention. In particular, numerical values may be higher or lower than ranges of numbers set forth above and still be within the scope of the invention. The described embodiments comprise different features, not all of which are required in all embodiments of the invention. Some embodiments of the invention utilize only some of the features or possible combinations of the features. Alternatively and additionally, portions of the invention described/depicted as a single unit may reside in two or more separate physical entities which act in concert to perform the described/depicted function. Alternatively and additionally, portions of the invention described/depicted as two or more separate physical entities (or software units) may be integrated into a single physical entity to perform the described/depicted function. Variations of embodiments of the present invention that are described and embodiments of the present invention comprising different combinations of features noted in the described embodiments can be combined in all possible combinations including, but not limited to use of features described in the context of one embodiment in the context of any other embodiment. The scope of the invention is limited only by the following claims.

All publications and/or patents and/or product descriptions cited in this document are fully incorporated herein by reference to the same extent as if each had been individually incorporated herein by reference.

1. A peer adapted for use in a peer-to-peer network, comprising:
(a) a memory storing therein only a part of an index of items available for search by said peer;
(b) a search module configured to search using the part of the index and corresponding parts stored on other peers; and
(c) a limiting module configured to maintain a load on said peer below a threshold.

2. A peer according to claim 1, wherein said load comprises a processing load of said peer.

3. A peer according to claim 1, wherein said load comprises an energy load of said peer.

4. A peer according to claim 1, wherein said load comprises a communication load of said peer.

5. A peer according to claim 1, wherein said load comprises a memory load of said peer.

6. A peer according to claim 5, wherein said memory load is limited as an absolute amount of memory.

7. A peer according to claim 5, wherein said memory load is limited as a percentage of a peer resource.

8. A peer according to claim 5, wherein said memory load limit is an absolute limit.

9. A peer according to claim 5, wherein said memory load limit is an average limit.

10. A peer according to claim 5, wherein said memory load limit comprises a limit on number of terms indexed for said items.

11. A peer according to claim 5, wherein said memory load limit comprises a limit on an amount of information stored per term.

12. A peer according to claim 5, wherein said part of an index includes a count of said available items.

13. A peer according to claim 5, wherein said part of an index includes an indication of a count of said terms whose indexing is incomplete.

14. A peer according to claim 1, wherein said limit includes at least one static component.

15. A peer according to claim 1, wherein said limit includes at least one dynamic component that changes at least once a day.

16. A peer according to claim 15, wherein said dynamic component depends on at least one of peer available resources and a costing scheme used by the peer.

17. A peer according to claim 1, comprising a memory storing therein at least ten documents available for said searching.

18. A peer according to claim 1, including a publishing module configured to publish to other peers terms indexible for an item.

19. A peer according to claim 1, including an un-publishing module configured to un-publish a previously published item.

20. A peer according to claim 1, including a term matching module configured to match a term to said part of an index.

21. A peer according to claim 1, including an output module configured to output at least one of:
(a) a part of said part of an index;
(b) a link to an item; and
(c) a document or document portion.

22. A peer according to claim 1, including a frequency estimation module configured to estimate a frequency of a term.

23. A peer according to claim 1, including a tradeoff estimation module configured to estimate a tradeoff between two or more search parameters.

24. A peer according to claim 23, wherein said tradeoff estimation module is configured to select a search type based on said estimation.

25. A peer according to claim 1, wherein said search module is adapted to execute an unstructured search.

26. A peer according to claim 1, wherein said search module is adapted to execute a structured search.

27. A peer according to claim 1, wherein said search module is adapted to execute a combined structured and unstructured search.

28. A peer according to claim 1, wherein said part of an index comprises an index for a full-text search.

29. A peer according to claim 1, wherein said peer is a battery limited mobile device.

30. A peer according to claim 29, wherein said peer is a cellular telephone.

31. A network comprising a plurality of peers according to claim 30.

32. A network according to claim 31, wherein not all of said peers have the same limits.

33. A network according to claim 31, comprising at least one non-peer member, which participates in at least one of searching and storage of documents.

34. A network according to claim 31, wherein no peer has stored thereon more than 5% of a combined index available for said items.

35. A network according to claim 31, comprising a redundancy of storage of indexes of at least a factor of 2.

36. A network according to claim 35, wherein redundant peers do not exactly duplicate each other.

37. A method of index management in a peer-to-peer network, comprising:
(a) distributing an index between a plurality of peers; and
(b) enforcing a size limit on the index at each peer.

38. A method according to claim 37, wherein enforcing comprises replacing index entries.

39. A method according to claim 37, wherein enforcing comprises dropping index entries.

40. A method according to claim 37, comprising performing a structured search using said limited indexes.

41. A method according to claim 40, wherein said search includes an unstructured component.

42. A method of searching in a peer-to-peer network, comprising:
(a) evaluating at least one consideration regarding the search; and
(b) based on said, evaluation performing at least one of a structured search, and unstructured search or a combined structured and unstructured search.

43. A method according to claim 42, wherein said search comprises a full-text search.

44. A method according to claim 42, wherein said consideration comprises cost.

45. A method according to claim 44, wherein said cost comprises a cost to a peer requesting the search.

46. A method according to claim 44, wherein said cost comprises a cost to the network.

47. A method according to claim 42, wherein said consideration comprises time.

48. A method according to claim 42, wherein said consideration comprises a frequency of one or more terms used in the search.

49. A method according to claim 48, wherein said frequency is based on a count of searchable items in said network.

50. A method according to claim 48, wherein said frequency is based on a count of terms in said network.

51. A method according to claim 42, wherein said combined search comprises search structured and unstructured at a same time.

52. A method according to claim 42, wherein said combined search comprises search structured and unstructured in series.

53. A method according to claim 42, wherein said combined search is based on results received during said search.

54. A method according to claim 42, wherein said combined search is based on prior provided information.

55. A method of combating adverse chum effects in a peer-to-peer network, comprising:
(a) providing a peer-to-peer system with required data distributed among the peers;
(b) monitoring availability of peers;
(c) identifying that a peer is unavailable;
(d) distinguishing if the unavailability is momentary; and
(e) applying a back-up procedure if it is determined that said unavailability is not momentary.

56. A method according to claim 55, wherein said back-up procedure comprises activating a redundant peer.

57. A method according to claim 55, wherein said back-up procedure comprises publishing information previously stored on said peer to one or more other peers.

58. A method according to claim 55, wherein said peer-to-peer network stores the data in a redundant form.

59. A method of estimating the frequency of a term use in a peer-to-peer system, comprising:
(a) requesting form at least one peer, one or both of a count of term use and a document count; and
(b) analyzing information received in response to said request, to generate a frequency estimation.

60. A method according to claim 59, wherein said request comprise a request for a document count.

61. A method according to claim 59, wherein said request comprise a request for a term count.

62. A method according to claim 59, wherein said request is made to a plurality of at least 10 peers.

63. A method according to claim 59, wherein analyzing comprises analyzing based on one or both of local term usage.

64. A method of searching in a peer-to-peer network, comprising:
(a) contact a plurality of peers to receive preliminary information regarding the search; and
(b) based on said preliminary information sending a search request to a plurality of peers.

65. A method according to claim 64, wherein said contacting comprises receiving information suitable to estimate a cost of a search.
